(19) United States
(12) Patent Application Publication
(10) Pub. No.: US 2001/0039536 A1
(43) Pub. Date: Nov. 8, 2001

(54) Cost data management system, method of managing cost data, and recording medium

(76) Inventors: Masahide Mori, Tokyo (JP); Kenichi Yano, Tokyo (JP); Shingo Ohtomo, Tokyo (JP); Yukio Tokunaga, Tokyo (JP)

Correspondence Address: RABIN & CHAMPAGNE, PC, 1101 14TH STREET, NW, SUITE 500, WASHINGTON, DC, 20005, US

(21) Appl. No.: 09/794,221

(22) Filed: Feb. 28, 2001

(30) Foreign Application Priority Data
Mar. 3, 2000 (JP) 058167/2000
Feb. 1, 2001 (JP) 025428/2001

(51) Int. Cl. G06F 17/00

(52) U.S. Cl. 705/400

(57) ABSTRACT

A cost data management system of the present invention has the following devices, so that it allows to easily obtain cost data on a designing component basis even though the production data is modified. That is, the design management computer 16 in the design data management system 10 is provided for managing design data of each designing component for a design subject. Also, the computer terminal 21 in the production management system 20 is provided for managing cost data of each manufacturing component in production data prepared on the basis of the design data. The external storage device 27 is provided for storing relationship-defining information that defines the relationship between a manufacturing component where a modification is made on its production data and a designing component in design data that corresponds to the manufacturing component. The production management computer 26 is provided for generating cost data of the designing component from cost data of the manufacturing component on the basis of the relationship-defining information. The cost data of the designing component is transmitted to the design management computer 16 and then is stored in the external storage device 17.

### BACKGROUND OF THE INVENTION

1. Field of the Invention

The present invention relates to a cost data management system, a method of managing cost data, and a recording medium to be respectively used in the cost data management system and the method of managing cost data, for managing cost data with respect to products, components, and so on, for a manufacturing company or the like involved in from the step of designing a product to the step of manufacturing such a product.

2. Description of the Prior Art

Conventionally, a manufacturing company or the like, which is involved in from the step of designing a product to the step of manufacturing such a product, generally conducts the product design at its designing department and the product manufacture at its manufacturing department (e.g., its manufacturing plant). In recent years, particularly, a production data management (PDM) system has been introduced in the designing department. Such a system has been utilized in the steps of developing a design of product, making a change in the design, and so on. The PDM system can be defined as means for managing design data including: configuration data that indicates a configuration of each designing component; item data thereof, and the like. In the manufacturing department, on the other hand, a production management system has been introduced as usual to manage production data required for the product manufacture, the cost actually required in the product manufacture, and so on. In this case, the production data is prepared on the basis of the design data.

Designers are occupied with the product design using computers with reference to the design data of products designed in the past. In this instance, by the way, it may be desirable to be able to comprehend the manufacturing costs with respect to a designing component to be assembled into a final product as a design subject for the purpose of reducing the cost of manufacturing the product. For grasping the manufacturing costs, heretofore, the designer sometimes called the person in charge of the manufacturing department, and asked about the costs. Alternatively, the designer accessed the data base governed with the production management system from the own computer and searched the desired cost data.

By the way, production data are not necessarily the same as the design data and it may be changed with consideration given to constraints of the manufacture in the manufacturing department. In the designing department, for example, a designing component is designed as a unity type in the design category. In the manufacturing department, on the other hand, there may be cases where the production data is modified so that the manufacturing component corresponding to such a designing component is manufactured as several sub-components to be assembled together to make up a finished component. In this case, the production management system manages the manufacturing costs on the basis of each sub-component as a management unit in accordance with the modified production data, for the manufacturing component. Like this, the unit of cost data being managed in the production management system does not necessarily correspond to the unit of designing component at a design level. Therefore, it is difficult for the designer to obtain the desired cost data by accessing the production management system from the own computer.

Accordingly, the present invention is conducted in view of the fact described above to provide a cost data managing system, a method of managing cost data, and a recording medium to be used in the system and the method.

### SUMMARY OF THE INVENTION

The present invention has been conducted in view of the fact described above. Therefore, an object of the present invention is to provide a cost data management system, a method of managing cost data, and a recording medium to be used in the system and the method, which are capable of easily obtaining cost data per every designing component in design data even though production data is changed.

In a first aspect of the present invention, for attaining the above object, there is provided a cost data management system that comprises: design data management means for managing design data of each designing component for a design subject; cost data management means for managing cost data of each manufacturing component in production data prepared on the basis of the design data; storage means for at least storing relationship-defining information that defines the relationship between a manufacturing component where a modification is made on its production data and a designing component in design data that corresponds to the manufacturing component; cost data generating means for generating cost data of the designing component from cost data of the manufacturing component which is managed by the cost data management means on the basis of the relationship-defining information; and output control means for controlling an output of cost data of the designing component that is generated by the cost data generating means when it receives an instruction for an output of the cost data of the specific designing component.

Here, the cost data management system may further comprises configuration means for configuring the relationship between the designing component and the manufacturing component by relating the designing component and the manufacturing component at a ratio of 1 to 1, 2 or more to 1, or 1 to 2 or more.

The output control means may display cost data of the designing component on a screen of a display means when it receives an instruction for an output of cost data of the specific designing component, and also the contents of the correspondence relationship on a screen of the display means when the correspondence relationship with the specific designing component is included in the relationship-defining information.

In a second aspect of the present invention, there is provided a cost data management system that comprises: a design data management system for managing design data of each designing component for a design subject; and a production management system for managing production data of each manufacturing component and cost data of each manufacturing component as a manufacturing subject, where the design data management system and the production management system are connected to each other through a network, wherein the production management system includes a storage means for at least storing relationship-defining information that defines the relationship between a manufacturing component where a modification is made on its production data and a designing component in design data that corresponds to the manufacturing component; and a cost data generating means for generating cost data of the designing component from cost data of the manufacturing component on the basis of the relationship-defining information, and the design data management system includes an output control means for controlling an output of cost data of the designing component that is generated by the cost data generating means when it receives an instruction for an output of the cost data of the specific designing component.

In a third aspect of the present invention, there is provided a method for cost data management. The method comprises the steps of: storing design data of each designing component for a design subject when a design of the design subject is completed; storing cost data of each manufacturing component in production data prepared on the basis of the design data; generating cost data of the designing component from cost data of the manufacturing component on the basis of the relationship-defining information that defines the relationship between a manufacturing component where a modification is made on its production data and a designing component in design data that corresponds to the manufacturing component; and outputting cost data of the designing component when an instruction for an output of the cost data of the specific designing component is received.

In a fourth aspect of the present invention, there is provided a recording medium comprising a computer program that executes each of the means of the cost data management system in the first and second aspects of the present invention.

In a fifth aspect of the present invention, there is provided a recording medium comprising a computer program that executes each of the steps of the method in the third aspect of the present invention.

In a sixth aspect of the present invention, there is provided a program product for providing a computer with functions to be acted as each of the means of the cost data management system in the first and second aspects of the present invention.

In a seventh aspect of the present invention, there is provided a program product for bringing a computer into action to execute each of the steps of the method in the third aspect of the present invention.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a schematic diagram that illustrates the cost data management system in accordance with one of the preferred embodiments of the present invention;

FIG. 2 is a schematic diagram that illustrates the configuration of the product being managed in the design data management system in the cost data management system in accordance with one of the preferred embodiments of the present invention;

FIG. 3 is a schematic diagram that illustrates the relationship-defining information being managed in the production management system in the cost data management system in accordance with one of the preferred embodiments of the present invention;

FIG. 4 is a schematic diagram that illustrates the pattern of configuring the relationship-defining information in accordance with one of the preferred embodiments of the present invention;

FIG. 5 is a schematic diagram that illustrates historical data being managed in the production management system of the cost data management system in accordance with one of the preferred embodiments of the present invention;

FIG. 6 is a schematic diagram that illustrates the flow of each data and the contents of processing each data in the cost data management system in accordance with one of the preferred embodiments of the present invention;

FIG. 7 is a schematic diagram that illustrates an example of the cost data retrieval screen applied in one of the preferred embodiments of the present invention;

FIG. 8 is a schematic diagram that illustrates an example of the retrieval results on the screen applied in one of the preferred embodiments of the present invention;

FIG. 9 is a schematic diagram that illustrates contents displayed on the screen when the detail button on the screen shown in FIG. 8 is activated by clicking on it with a mouse or the like;

FIG. 10 is a schematic diagram that illustrates an example of the cost data retrieval screen applied in one of the preferred embodiments of the present invention;

FIG. 11 is a schematic diagram that illustrates an example of the retrieval results on the screen applied in one of the preferred embodiments of the present invention;

FIG. 12 is a schematic diagram that illustrates another example of the retrieval results on the screen; and

FIG. 13 is a schematic diagram that illustrates contents displayed on the screen when the detail button on the screen shown in FIG. 12 is activated by clicking on it with a mouse or the like.

### DETAILED DESCRIPTION OF PREFERRED EMBODIMENTS

Referring now to the attached drawings, we will describe one of the preferred embodiments of the present invention in detail.

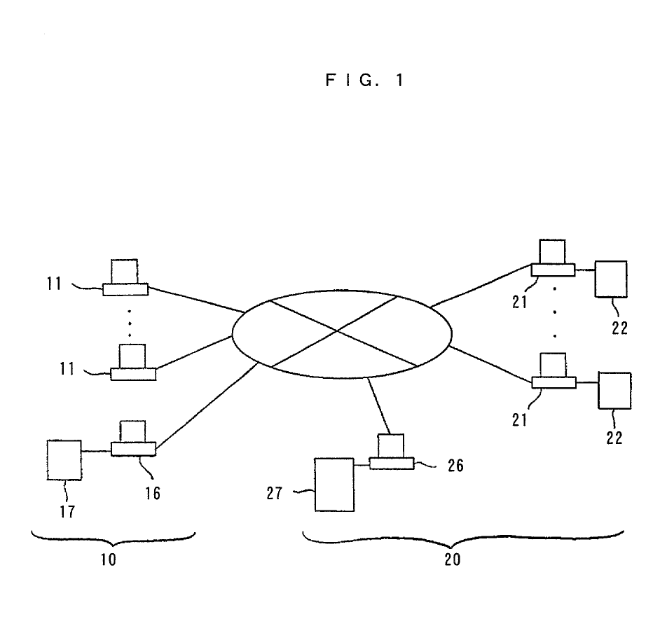

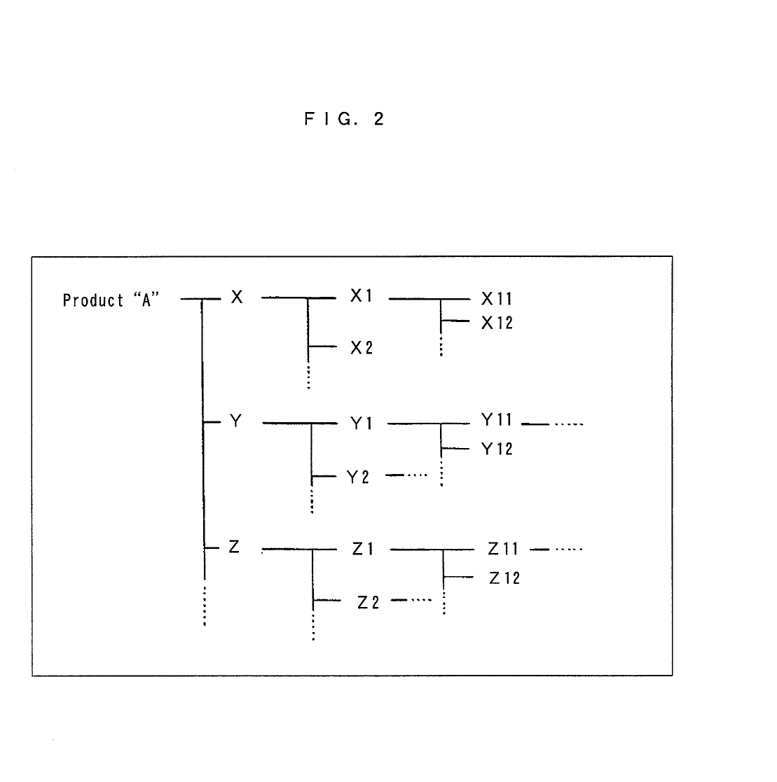

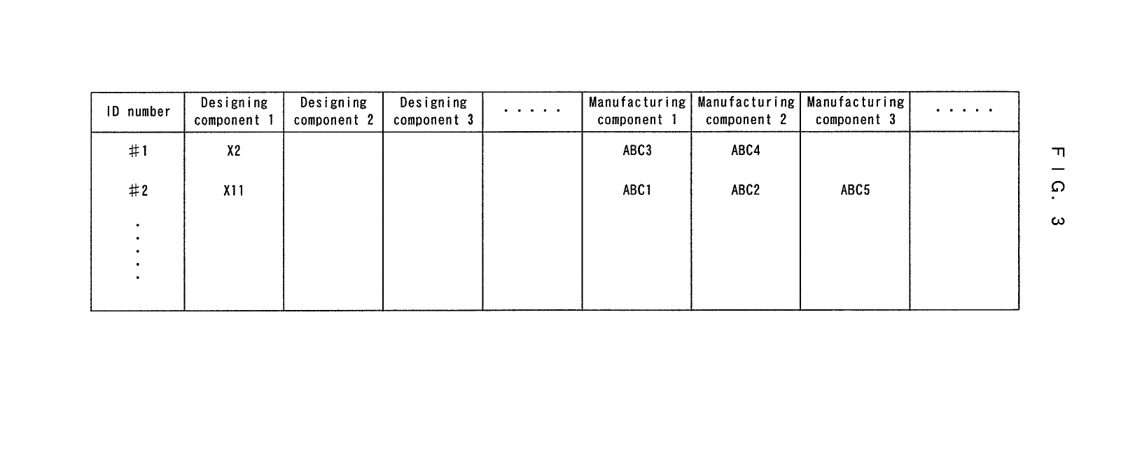

In FIG. 1, a cost data management system in accordance with one of the preferred embodiment of the present invention is schematically illustrated. In FIG. 2, in addition, a configuration of a product being managed in a design data management system in the cost data management system is illustrated. Furthermore, FIGS. 3, 4, and 5 schematically illustrate relationship-defining information being managed in a production management system of the cost data management system, the pattern of configuring the relationship-defining information, and historical data being managed in the production management system of the cost data management system, respectively.

The cost data management system of the present invention is responsible for managing cost data with respect to products, components, and so on, for a manufacturing company or the like involved in from the step of designing a product to the step of manufacturing such a product.

As shown in FIG. 1, the cost data management system comprises a design data management system 10 and a production management system 20, which are activated by running a program loaded on the cost data management system. In this embodiment, we take an example of manufacturing the products in an assembly line where a plurality of components is assembled into the products. In this embodiment, furthermore, the component in design at a designing department is referred to as a designing component, while the component substantially in process at a manufacturing department (e.g., a manufacturing plant) is referred to as a manufacturing component.

The design data management system 10 is placed on the designing department in the company and comprises a plurality of computer terminals 11 and a design management computer 16 connected to the computer terminals 11 through a network well known in the art, allowing data transfers between the computer terminals 11 and the design management computer 16. In this embodiment, by the way, as will be appreciated by a person with ordinary skill in the art, the network may further include additional computers and associated devices such as printers that are connected by communications facilities. In addition, the network may involve permanent connections, such as cables, or temporary connections made through telephone, wireless communication, or other communication links. Furthermore, the network can be as small as a LAN (local area network) or it can consist of many small and large computers distributed over branch offices.

Each designer in the designing department performs the designing operation of products using the computer terminal 11, or equivalently the designer works out a design of products and makes a modification to improve the design, and so on. Then, the resulting design data from the designing operation is transmitted to the design management computer 16.

The design management computer 16 performs the transmission and reception of data with each of the computer terminals 11 and manages design data entered from each of them. The design management computer 16 connects to an external storage device 17 that stores a database. The database holds design data, cost data, and so on. In this case, the design data includes item data and design configuration data in addition to design drawings with respect to each product and its designing components. The item data represents descriptions of the designing components. For example, the item data includes information that the designing components concerned are finished products or purchased products. The design configuration data represents the constitutional relationship between one designing component and the other designing components. For example, it represents information about the designing components to be assembled together in which the designing component concerned should be used. In addition, cost data stored in the external storage device 17 is based on each designing component designed in the past and transmitted from a production management system 20 as described latter.

The design management computer 16 can make a configuration diagram about the product on the basis of the design construction data. In FIG. 2, there is shown a configuration diagram of the product “A” as a tree structure displayed on a screen of display device. As shown in FIG. 2, the product “A” comprises a plurality of designing components X, Y, Z, and so on and each of them further comprises their respective sets of components. That is, the designing component “X” is further comprised of X1, X2, and so on. The designing component “Y” is further comprised of Y1, Y2, and so on. The designing component “Z” is further comprised of Z1, Z2, and so on. Furthermore, for example, the designing component “X1” is comprised of designing components X11, X12, and so on. In this way, the product as a processed assembly comprises a plurality of designing components configured as if to be arranged hierarchically in several layers. Therefore, the designer belonging to the designing department may display such a configuration diagram about the products manufactured in the past on a screen of the computer terminal 11 and designs any product with reference to the diagram.

As shown in FIG. 1, the production management system 20 comprises a plurality of computer terminals 21 and a production management computer 26. These computer terminals 21 connect to the production management computer 26, to build up a network. Thus, the computer terminals 21 and the production management computer 26 are able to perform data transmission and reception with each other. Furthermore, both the computer terminals 21 and the production management computer 26 connect to the design data management system 10 through the network. Therefore, for example, the production management computer 26 is able to receive design data from the design data management system 10.

Each computer terminal 21 is placed on each manufacturing department (i.e., each manufacturing plant) and manages production data and cost data with respect to each manufacturing component of the product. In addition, an external storage device 22 that stores database is connected to each computer terminal 21. The database holds actual purchase order data, estimation data, actual production data, process data, and so on in addition to production data and cost data. The production data includes item data, production configuration data, and so on. The item data represents descriptions of manufacturing components, while the production configuration data represents the structural relationship between one manufacturing component and the other manufacturing components. The production configuration data is almost the same as the design configuration data held in the above design data for the same product. In this case, however, there may be cases that the production configuration data becomes different from the design configuration data when the contents of the production configuration data are modified.

The actual purchase order data represents the actual purchase order when the manufacturing component is a product to be purchased, while the estimation data represents the contents of the estimation received from the procurement source of purchasing product. Furthermore, the actual production data represents the actual production when the manufacturing component is the resulting product. The process data defines job standard time, hourly pay, and so on for manufacturing the product.

Moreover, each computer terminal 21 has the function of calculating cost, so that it calculates costs of all manufacturing components every predetermined period, for example once every week. By the way, the reason of calculating the cost every predetermined period is that each manufacturing plant manages costs on the basis of actual results and such costs vary every day. In the present embodiment, furthermore, cost expense items are summarized in four items of material expense, purchase expense, processing expense, and general management expense, and then costs of these items are calculated. The calculated cost data for each manufacturing component is stored in the database in the external storage device 22.

The production management computer 26 may be placed on a corporate-wide common department in the company. An external storage device 27 for storing temporary files and databases is connected to the production management computer 26. The temporary file is provided as a working storage area for performing predetermined work on the design data transmitted from the design data management system 10. In addition, the database in the external storage device 27 stores production data, design data transmitted from the design data management system 10, and so on. Generally, the production data is the same as production data stored in the external storage device 22 of each computer terminal 21.

The production management computer 26 has the functions of configuring the correspondence relationship and generating design cost data. The function of configuring the correspondence relationship allows the configuration of the correspondence relationship between the designing component in the design data and the manufacturing component in the production data. Because of various constraints in production, there is rugged case in the manufacturing plant to manufacture the product based on the production data prepared by simply copying the design data. In this case, there is a necessity to modify the production data by making a change to the configuration of components in the production data. If the specified person in charge uses the function of configuring correspondence relationship to configure the correspondence relationship between the designing component and the manufacturing component, the component configuration of the production data is changed in accordance with the contents of that correspondence relationship.

Relationship-defining information that is a set of the correspondence relationships is stored in the database in the external storage device 27.

One of the examples of such relationship-defining information is shown in FIG. 3. The relationship-defining information is configured as a table structure. In the table, there are several columns of: “Identification (ID) numbers”, “Designing component”, and “Manufacturing component”. In addition, more than two columns of the designing component and the manufacturing component are provided, respectively. The “ID numbers” are responsible for recognizing each correspondence relationship. In FIG. 3, there is shown an example of changing the component configuration of the production data with respect to the product “A” shown in FIG. 2. In the design data, as shown in FIG. 2, the designing component “X” of the product “A” is comprised of a plurality of designing components X1, X2, and so on and the designing component X2 consists of a single article. In the correspondence relationship with the ID number of “#1”, as shown in FIG. 3, “X2” is described in the column “Designing component 1”, and “ABC3” and “ABC4” are described in the columns “Manufacturing component 1” and “Manufacturing component 2”, respectively. This indicates that the production data is changed so that the manufacturing component corresponding to the designing component “X2” is comprised of two manufacturing components “ABC3” and “ABC4”. As shown in FIG. 2, furthermore, the designing component “X1” consists of a single article. The correspondence relationship with the ID number of “#2” indicates that the production data is changed so that the manufacturing component corresponding to the designing component “X11” consists of three manufacturing components: “ABC1”, “ABC2”, and “ABC5”.

In the present embodiment, furthermore, the correspondence relationship between the manufacturing component and the designing component can be configured with respect to only the manufacturing component with modified production data. The designing component that is not included in the relationship-defining information may be recognized as the same as the corresponding manufacturing component in the production data. In this case, however, it can be safely said that the correspondence relationship between the manufacturing component and the designing component can be configured.

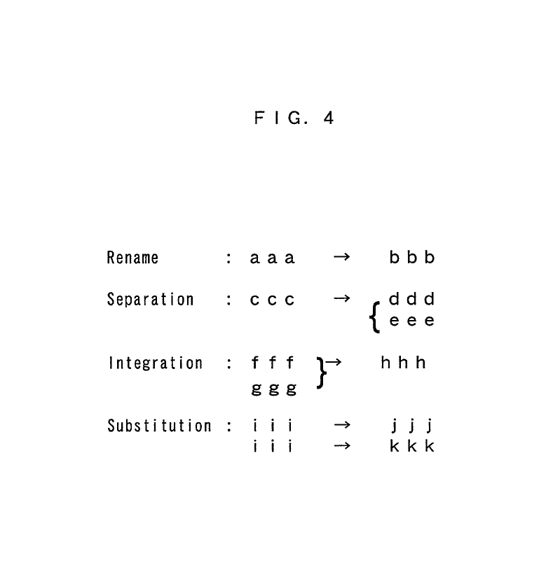

As the configuration pattern of this correspondence relationship, concretely, there are four patterns: “Separation”, “Integration”, “Substitution”, and “Rename”. FIG. 4 shows concrete examples of four configuration patterns. The “Separation” is the pattern in which the manufacturing component corresponding to a single designing component is constructed of a plurality of the manufacturing components. It means that the correspondence relationship between the designing component and the manufacturing component is in the ratio of 1 to 2 or more. An example of such a “Separation” may be the correspondence relationship of “#1” and “#2” in FIG. 3. The “Integration” means that the manufacturing-component corresponding to a plurality of designing components is manufactured as a single manufacturing component. This case corresponds to the case in which the correspondence relationship between the designing component and the manufacturing component is configured to be in the ratio of 2 or more to 1 as shown in FIG. 4. The “Substitution” means that in place of the manufacturing component corresponding to a specific designing component, another manufacturing component may be used. In the case of manufacturing a clock, for example, a second hand with the specific model number was used in the designing department. Presently, however, if it is possible to use the manufacturing component with the different model number, both the former manufacturing component with the initially defined model number and the replaceable manufacturing component may be used. As shown in FIG. 4, the “Substitution” is of the case where for a specific designing component, a plurality of configurations is made for the correspondence relationship between the specific designing component and the manufacturing component and each of them is configured to be in the ratio of 1 to 1. In addition, the “Rename” is of the case where the name of manufacturing component corresponding to a specific designing component is changed to another name. As shown in FIG. 4, it corresponds to the case where the only correspondence relationship between the designing component and the manufacturing component is in the ratio of 1 to 1.

Furthermore, additional configuration patterns may be considered other than “Separation”, “Integration”, “Substitution”, and “Rename”. However, the above four patterns can be sufficiently used at the present.

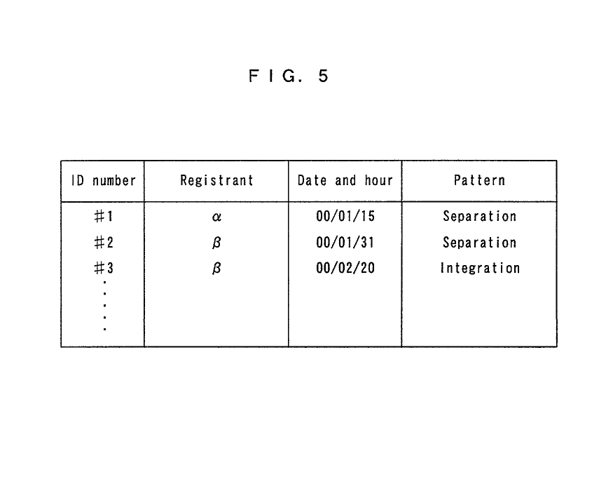

This correspondence relationship is configured by a person in charge thereof using the function of configuring the correspondence relationship in the production management computer 26. At this time, the predetermined historical data is entered in the database in the external storage device 27. One example of such historical data is shown in FIG. 5. In this figure, the historical data has a table structure in which columns of “Registrant”, “Date and hour”, and “Pattern” are provided every each column of “ID number”. The “ID number” makes a link between the historical data and the relationship-defining information of FIG. 3. In the column of “Registrant”, the name of a person in charge of configuring the correspondence relationship is described. In the column of “Date and hour”, the date and hour when the person configured the correspondence relationship is described. In the column of “Pattern”, subsequently, the discrimination of four configuration patterns, that is, one of four configuration patterns described above, “Separation”, “Integration”, “Substitution”, and “Rename” to be corresponded to the correspondence relationship is described. The “ID number” and the “Date and hour” may be automatically filled in accordance with the function of configuring the correspondence relationship in the production management computer 26. However, a person in charge thereof should fill the column of “Pattern” voluntarily. Furthermore, the column of “Registrant” may be voluntarily filled or automatically configured using user information for terminal operation. In the table of historical data, the column of “Pattern” may be omitted.

Furthermore, the function of generating design cost data in the production management computer 26 is responsible for generating cost data of the designing component from cost data of the manufacturing component being stored in the external storage device 22 of each computer terminal 21 on the basis of the relationship-defining information in which the correspondence relationship between the design component and the production component is defined. If there is the disparity between the contents of the design data and the production data, cost data per manufacturing component may be not effectively used even if the cost data per manufacturing component is received in the designing department. For this reason, the function of generating design cost data allows that the designer of the designing department easily comprehend the contents of the cost data by generating cost data per every designing component included in the designing data to reflect the information of cost to the design development, design change, and so on.

More specifically, the production management computer 26 receives cost data from each of the computer terminals 21 whenever each of them calculates the cost data of each manufacturing component included in the production data once a week. Depending on such cost data and the relationship-defining information, cost data (design cost data) of each designing component included in the design data is generated. Subsequently, the production management computer 26 sends the design cost data to the design management computer 16 of the design data management system 10. The design management computer 16 stores the design cost data in a database in the external storage device 17.

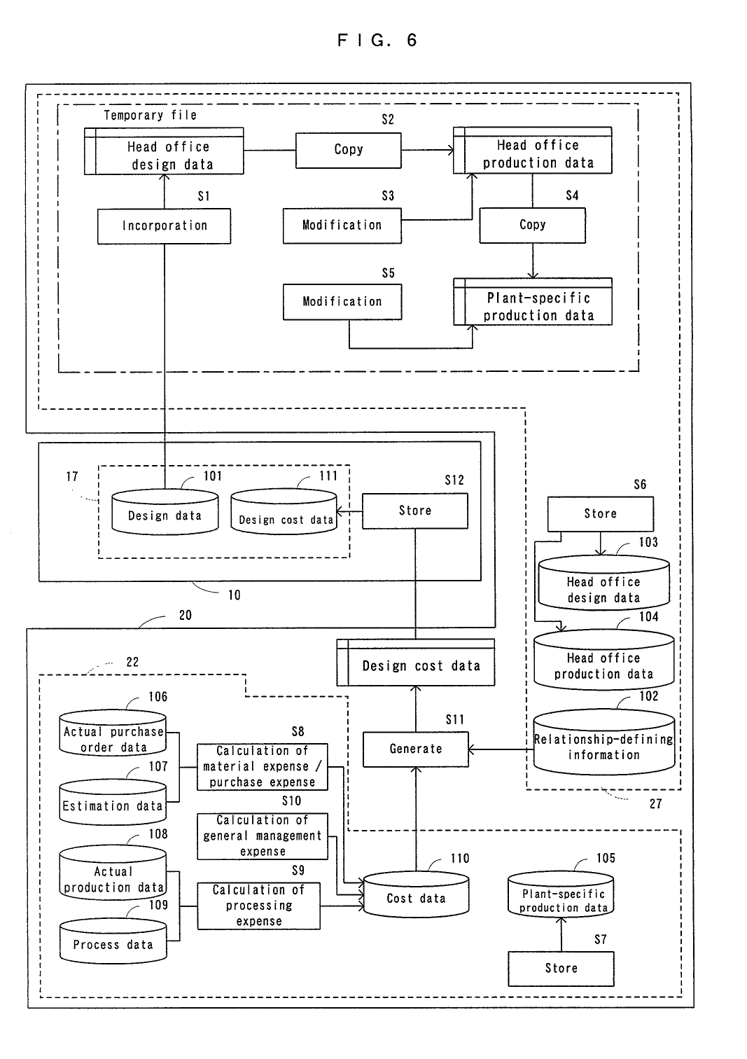

Next, we will describe each step of the procedure in the cost data management system of the present embodiment. FIG. 6 is a schematic diagram of the cost data management system for illustrating the flow of each data and the steps of processing each data. In FIG. 6, furthermore, graphic representations of each of the computer terminals, the management computer, and so on in the design data management system 10 and the production management system 20 are omitted.

Here, Let us suppose that the design development is performed on the product “A” using one of the computer terminal 11 in the design data management system 10. When the design development of the product “A” is completed, the computer terminal 11 sends the design data 101 of the product “A” to the design management computer 16 while the design management computer 16 stores such design data 101 in the database in the external storage device 17. In addition, the design management computer 16 transmits the design data 101 of the product “A” to the production management computer 26 of the production management system 20. Then, the production management computer 26 incorporates the design data 101 of the product “A” (at the step of “S1”), and then the design data 101 is stored as the head office design data in a temporary file in the external storage device 27. Subsequently, the production management computer 26 generates head office production data by making a copy of the head office design data (at the step of “S2”).

In the manufacturing plant, for the next step, the product “A” is manufactured by way of trial in accordance with the head office production data. Following that, at the common department in the head office, the persons in charge of the manufacturing department and the persons in charge of the designing department are gathered together and the product “A” is taken up at the meeting. At this time, if several problems are brought up at the meeting, such as a difficulty of manufacturing the product “A” in accordance with the head office production data, those persons discuss to strike out the best countermeasure. Then, according to the countermeasure, each person configures the correspondence relationship between designing components in the head office design data and manufacturing components in the head office production data using the function of configuring the correspondence relationship in the production management computer 26, to make a modification to the head office production data (at the step “S3”). If the above correspondence relationship is configured as shown in FIG. 3, the head office production data having the new component configuration in accordance with the correspondence relationship shown in FIG. 3 is obtained. In addition, the correspondence relationship being configured is stored as relationship-defining information 102 in a database in the external storage device 27.

Following the above steps, the production management computer 26 makes copies of the head office production data as much as the number of the locations (manufacturing plants) for manufacturing the production “A” to obtain plant-specific production data (at the step of “S4”).

By the way, the correspondence relationship configuration function of the production management computer 26 is capable of individually making a modification to each plant-specific production data (at the step of “S5”). For example, if the meeting at the common department in the head office has decided to construct one manufacturing component from two small manufacturing components and one of the plants has a high-efficient working machine capable of easily performing complicated processing, there is no need to make a modification to the plant-specific production data for this plant as the plant is capable of manufacturing the manufacturing component without any modification on its plant-specific production data. In another plant, on the other hand, if it is difficult to manufacture such a manufacturing component without any modification to its plant-specific production data, the plant-specific production data should be modified to construct the manufacturing component from two small manufacturing components. Therefore, there is a need to add the column of “Plant number” on the table of the relationship-defining information shown in FIG. 3 so as to configure the correspondence relationship between the designing component and the manufacturing component at every plants. If the correspondence relationship is commonly applied on the whole company, for example, a number indicating that the correspondence relationship is shared across the board is provided on the column of “Plant number”. If the correspondence relationship is applied on part of the plants, a specific identification number indicating the part of the plants is provided on the column of “Plant number”, so that the plant-specific production data can be modified on a plant basis.

Next, the production management computer 26 stores both the head office design data 103 and the head office production data 104 in a database in the external storage device 27 (at the step of “S6), and simultaneously sends the plant-specific production data 105 to the computer terminal 21 placed on each plant. Each of the computer terminals 21 receives this plant-specific production data 105 and then stores it in a database in the external storage device 22 (at the step of “S7”). In this case, more concretely, the plant-specific production data 105 is newly added and stored in the database in the external storage device 22 if the plant-specific production data 105 is of the new product. On the other hand, the plant-specific production data 105 is updated and stored in the database in the external storage device 22 if the plant-specific production data 105 is of the design-modified product.

Each of the computer terminals 21 calculates costs of the respective manufacturing components included in the plant-specific production data 105 on the basis of actual purchase order data 106, estimation data 107, actual production data 108, and process data 109, for example on a weekly basis (at the steps of “S8”, “S9”, and “S10”). In this embodiment, such a cost calculation is performed with respect to four different expense items: material expense, purchase expense, processing expense, and general management expense. The item to be subjected to the cost calculation may be determined on the basis of item data included in the plant-specific production data 105. For example, if the contents of item data are “manufacturing article”, the cost calculation is performed with respect to material expense, processing expense, and general management expense. On the other hand, if the contents of the item data is “purchased article”, the cost calculation is performed with respect to purchase expense and general management expense. In this case, the material expense or the purchase expense may be calculated on the basis of the actual purchase order data 106 if the purchase is actually performed. If the purchase is not performed yet, the material expense or the purchase expense is calculated on the basis of the estimation data 107. Regarding the processing expense, it is calculated on the basis of the actual production data 108 if the production is actually performed. On the other hand, it is calculated on the basis of the process data 109 if the production is not performed yet. The calculated cost data 110 of each manufacturing component is stored in the database in the external storage device 22.

In addition, each of the computer terminals 21 sends cost date of each manufacturing component to the production management computer 26 on a weekly basis. The production management computer 26 receives the cost data of each manufacturing component and then generates cost data of each designing component (design cost data) from the cost data of each manufacturing component on the basis of the relationship-defining information stored in the external storage device 27 (at the step of “S11”). The production management computer 26 sends the generated design cost data to the design management computer 16 of the design data management system 10. Subsequently, the design management computer 16 receives the design cost data 111 and stores it in the database in the external storage device 17 (at the step of “S12”). Consequently, the latest design cost data is transmitted to the designing department on a weekly basis. Thus, if the designer at the designing department performs a design operation using own computer terminal 11 and desires the cost data of the interested designing component, the designer can easily obtain the latest cost data of the interested designing component by accessing the design management computer 16.

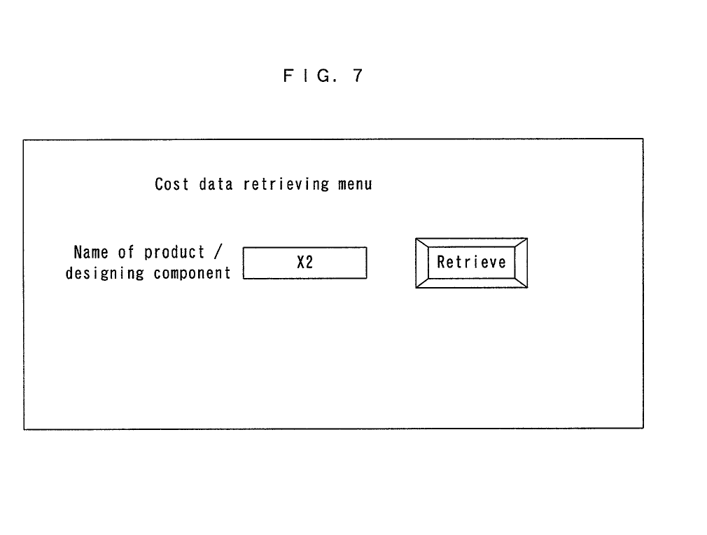

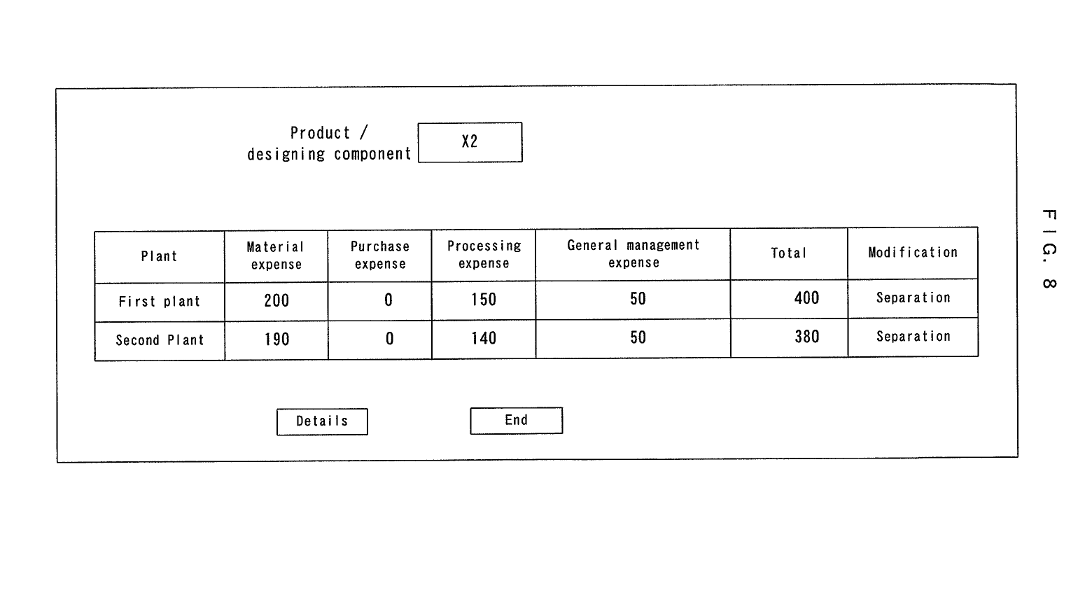

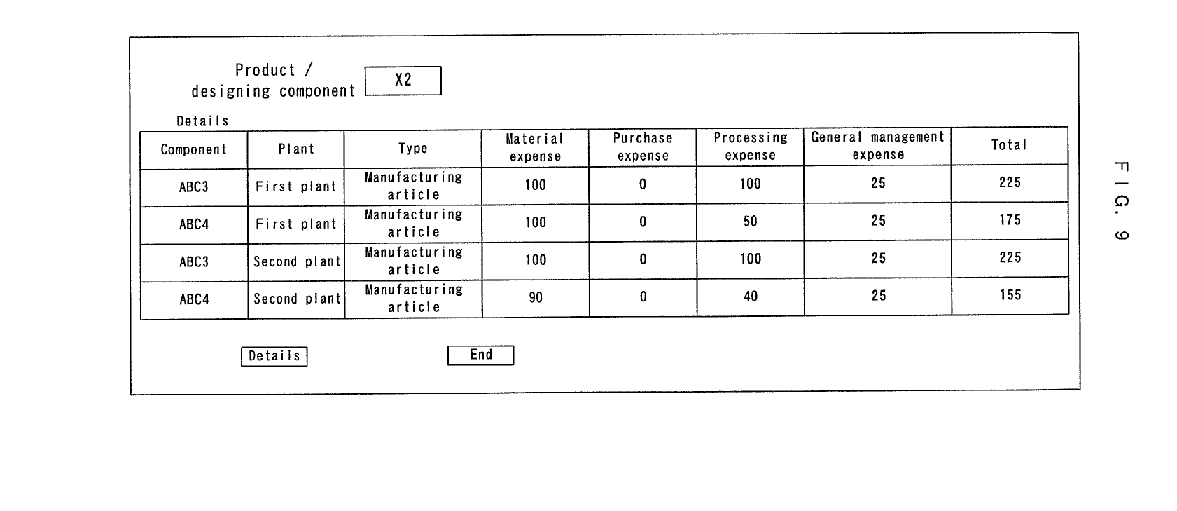

Next, in the cost data management system of the present embodiment, we will describe the procedure for displaying the cost data on a screen of the computer terminal 11 belonging to the designer at the designing department. FIG. 7 illustrates an example of a cost data retrieving menu on the screen, FIG. 8 illustrates an example of the screen that represents the results of retrieving the cost data, and FIG. 9 illustrates an example of the screen when the detail button on the screen shown in FIG. 8 is activated by clicking on it with a mouse or the like.

During the design operation, the designer activates his or her own computer terminal 11 to display the screen of cost data retrieving menu shown in FIG. 7 when the designer desires costs of the designing component “X2” of the product “A” being manufactured in the past. There is a field of “Name of product or designing component” and a button of “Retrieve” on the retrieving screen. The name of the product or the designing component corresponding to the cost that the designer wants to know is entered in the field of “Name of product or designing component”. In this case, the designer enters “X2” in the field of “Name of product or designing component”. Subsequently, the designer pushes the “Retrieve” button by mouse or the like and then the computer terminal 11 starts to make an inquiry about the cost data of the designing component “X2” to the design management computer 16. The design management computer 16 sends the cost data of the designing component “X2” stored in the database in the external storage device 17 to the computer terminal 11, so that the retrieving results are displayed on the screen of the computer terminal 11 as shown in FIG. 8.

In the retrieving results on the screen, the costs of the designing component “X2” for each of the plants (i.e., a first plant and a second plant) are displayed with respect to each of the expense items. The items include “Material expense”, “Purchase expense”, “Processing expense”, and “General management expense” in addition to the total costs thereof. In the first plant, as shown in FIG. 7, for example, the total cost of the designing component “X2” is ¥400 (“¥” is Japanese YEN). The breakdown of the total cost is as follows. The material expense is ¥200, the processing expense is ¥150, and the general management expense is ¥50. In the second plant, on the other hand, the total cost of the designing component “X2” is ¥380. The breakdown of the total cost is as follows. The material expense is ¥190, the processing expense is ¥140, and the general management expense is ¥50. From these retrieving results, the designer finds that the total cost of the designing component “X2” manufactured in the second plant is cheaper than another one. By the way, the screen may be provided for individually each plant.

On the screen of the retrieving results, furthermore, the contents of the configuration pattern of the correspondence relationship with respect to the desired designing component may be displayed if such correspondence relationship is already configured. Regarding the designing component “X2”, as shown in FIG. 3 and FIG. 5, the correspondence relationship is configured by the “Separation” pattern, so that “Separation” is represented on the right side of the column of cost for each plant. Therefore, the designer can easily recognize the fact that the design of the designing component “X2” is modified and the content of such modification.

Furthermore, as shown in FIG. 8, there is a button of “Details” on the screen of the retrieving results. The “Details” button is provided for displaying the cost data of smaller designing components that make up the retrieving-target product or the retrieving-target designing component. Thus, the smaller designing components are positioned on next lower layer from the retrieving-target product or the target-designing component in the configuration diagram of the product shown in FIG. 2. In particular, if the correspondence relationship is configured by the “Separation” pattern with respect to the retrieve-target designing component, the cost data of each manufacturing component specified by such correspondence relationship can be displayed on the screen.

On the screen of the retrieve results shown in FIG. 8, for example, the computer terminal 11 starts to make an inquiry about the cost data of each of the manufacturing components “ABC3” and “ABC4” described in the correspondence relationship with respect to the designing component “X2” to the design management computer 16 when the designer clicks the “Details” button using a mouse or the like. In this case, the design management computer 16 does not manage the cost data of both the manufacturing components “ABC3” and “ABC4”, so that it makes an inquiry about them to the product management system 20 to receive the cost data of the manufacturing components “ABC3” and “ABC4” therefrom. Subsequently, the design management computer 16 sends the cost data to the predetermined computer terminal 11. Consequently, a list as shown in FIG. 9 is displayed on a screen of the computer terminal 11. The list displayed on the screen includes the types and cost data of the manufacturing components for each plant with respect of each of the manufacturing components “ABC3” and “ABC4”. In the field of the “Type”, by the way, the contents of item data with respect of the manufacturing component are described. Therefore, the designer can easily recognize the cost data of the manufacturing components or designing components that make up the predetermined designing component if required.

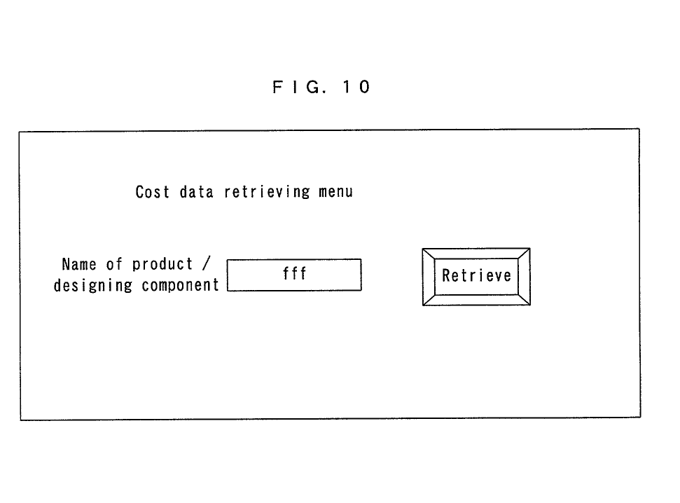

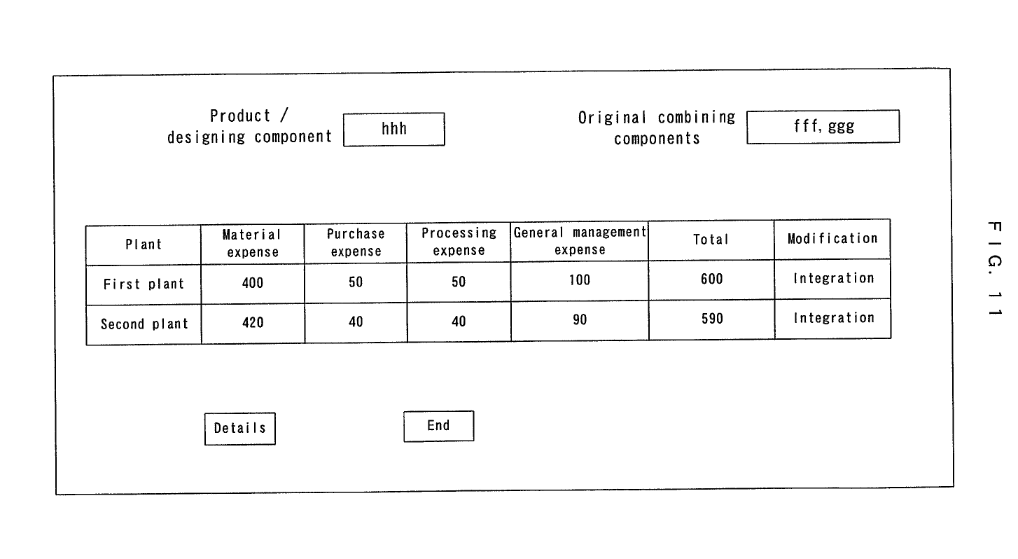

Next, we will describe the case where the cost of the designing component on which the “Integration” pattern is configured as the correspondence relationship. FIG. 10 is a schematic diagram that illustrates an example of the cost data retrieving menu on the screen applied in one of the preferred embodiments of the present invention, and FIG. 11 is a schematic diagram that illustrates an example of the retrieval results on the screen. For example, the designing component “fff” and the designing component “ggg” are combined together to manufacture a single manufacturing component “hhh” corresponding to the designing components “fff” and “ggg”. In this case, the designer enters “fff” as a retrieving-target component in “Name of product/designing component” and then clicks the “Retrieve” button by a mouse. As a result, the retrieving results are represented on the screen as shown in FIG. 11. In this case, the name of the combined component “hhh” that actuary obtained cost data, instead of the name of the retrieving-target component “fff”, is displayed on the field of “Name of product/designing component”. For indicating that the combined component “hhh” is a combination between the retrieving-target component “fff” and the component “ggg”, “fff, ggg” is represented on the field of “Original combining components”. In addition, above the screen of the retrieving results, costs of the combined component “hhh” for each of the plants are displayed with respect to each of the expense items: material expense, purchase expense, processing expense, and general management expense, in addition to the total costs thereof. Furthermore, the desired component is configured by the “Integration” pattern of the correspondence relationship, so that “Integration” is represented on the right side of the column of cost for each plant. In this example, furthermore, the same retrieving results as those of FIG. 11 can be obtained when the retrieve is performed by entering “ggg” in the “Name of product/designing component” on the cost data retrieving menu on the screen shown in FIG. 10. In addition, the screen may be provided for individually each plant.

In summary, the cost data management system of the present embodiment has the relationship-defining information that defines the correspondence relationship between the designing component in the design data and the manufacturing component in the product data. Cost data of the designing component is generated from cost data of the manufacturing component being managed by the production management system on the basis of that relationship-defining information. Then, the cost data of the designing component is stored in the external storage device of the design data management system. Consequently, the designer can easily obtain the cost data on a designing component basis even if the production data is modified.

By the way, the present invention has been described in detail with respect to preferred embodiment, and it will now be obvious to those skilled in the art that changes and modifications may be made without departing from the scope of the invention.

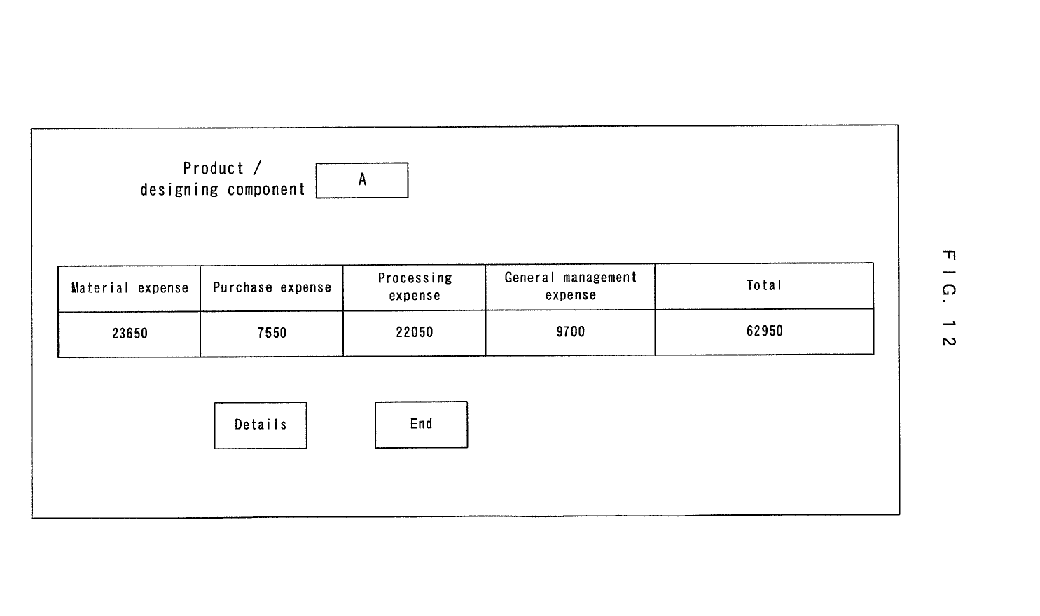

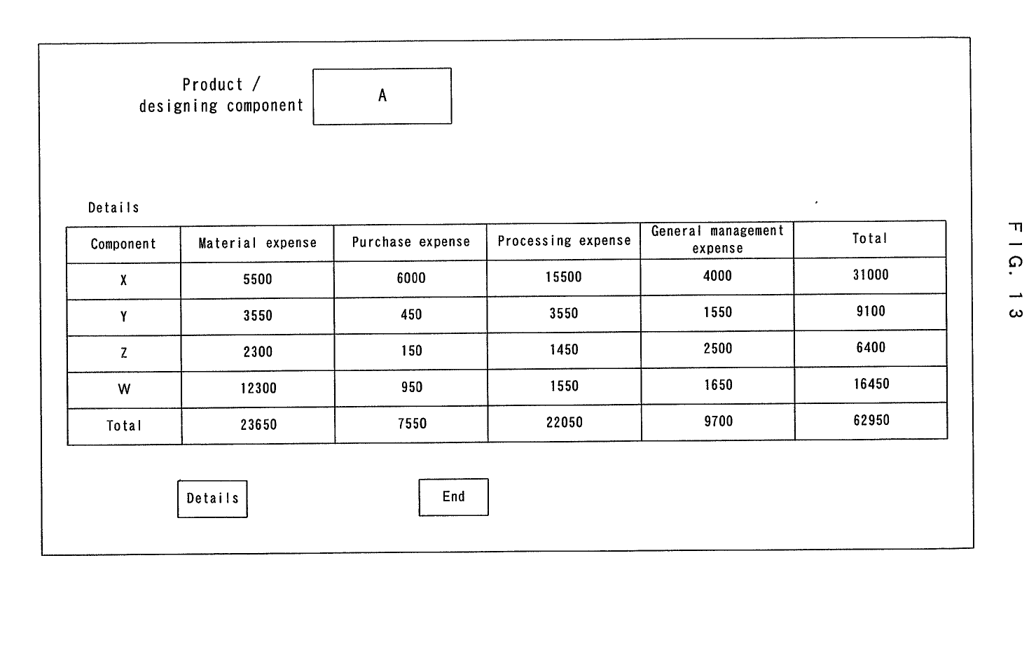

For example, the above embodiment has been described with respect to the case where the cost data of the desired product or the desired designing component for each of the plants is displayed on the screen of the retrieving results of cost data. However, it is not limited to such a configuration. It is also possible to display only the lowest cost of the desired product or the desired designing component on the screen of the retrieving results. In this case, for example, as shown in FIG. 12, the lowest cost data with respect to the product “A” can be only represented on the screen of the retrieving results when “A” is entered in the field of “Name of product/designing component” on the cost data retrieving menu on the screen shown in FIG. 7 and then the “Retrieve” button is clicked. When the “Details” button is clicked, subsequently, the details of the cost data of FIG. 12 are represented on the screen as shown in FIG. 13. That is, the cost data with respect to each designing components X, Y, Z, W, and so on, which are positioned on the next lower layer from the target product “A” in the configuration diagram shown in FIG. 2. Furthermore, as shown in FIG. 8 and FIG. 11, the pattern such as “Separation” and “Integration” may be displayed on the screen.

The above embodiment has been described with respect to the case where the cost of the product or the designing component is displayed on the screen of the retrieving results of cost data in the form of expense items which are summarized in four items of material expense, purchase expense, processing expense, and general management expense. Particularly, if the designer would like to know the cost data with respect to the detailed lower-level expense items included in those four higher-level expense items, the computer terminal placed on each plant may further manage the cost data with respect to such lower-level expense items. Thus, the designer clicks the sum of the desired higher-level expense item on the screen by mouse or the like and then the computer terminal placed on the designing department starts to make an inquiry about the cost data of the lower-level expense item included in the higher-level expense item to the production management system.

In the above embodiment furthermore, there is described the production management system that generates cost data for each designing component and sends the cost data to the design data management system every time after passing a predetermined period. In this case, alternatively, it is also possible to construct the system as follows. For example, if the designer pushes the “Retrieve” button on the screen by mouse or the like, then the design data management system starts to make an inquiry of sending cost data with respect to the desired product or the desired designing component to the production management system. Thus, the production management system generates cost data and sends the cost data to the design data management system every time the later receives the inquiry from the design data management system. In this case, it is preferable that the production management system generates: cost data with respect to the desired product or the desired designing component; and cost data with respect to the designing components which are positioned at least on the next lower layer from the desired product or the desired designing component in the configuration diagram, and transmits those cost data to the design data management system.

In the above-preferred embodiment, the present invention is applied in the case where the production management system and the design data management system are connected to each other by means of the network. Alternatively, the cost data management system of the present invention may be realized using one computer.

It goes without saying that the object of the present invention can be also attained by providing program codes (execute forms) of a software that realizes the functions of the system and the terminal in the above-mentioned embodiment for the system or the device by the recording medium in which the whole or part of the program codes is stored, and by executing the whole or part of the operation by reading out the program codes stored in the recording medium by the computer (or CPU, MPU) equipped in the system or the device.

In this case, the program codes itself read out of the recording medium are able to realize the functions of the present embodiment. Thus, the recording medium on which such program codes are stored may construct the present invention.

The recording medium for the supply of program codes may include ROM, floppy disk, hard disk, optical disk, magneto-optical disk, CD-ROM, CD-R, magnetic tape, nonvolatile memory card or the like.

It is needless to say that the computer may read out the program codes to execute them to realize the functions of the present embodiment and also the whole or part of the actual processing may be executed by the operation system (OS) running on the computer in accordance with the instruction of the program codes described above to realize the functions of the present embodiment.

Furthermore, the program codes read out of the recording medium may be written in a memory equipped in the expanded capability board inserted in the computer or the expanded capability unit connected to computer. Thus, it is needless to say that the CPU or the like equipped on the expanded capability board or unit performs the whole or part of actual processing that realizes the functions of the present invention.

In addition, the present invention may be a program product comprising any program that operates at least one computer as any means in the cost data management system or method of the present invention. By the way, the program product implies a computer and a recording medium comprising a program in addition to a computer program.

For example, the program product may act as design data management means for managing design data of each designing component for a design subject; cost data management means for managing cost data of each manufacturing component in production data prepared on the basis of the design data; storage means for at least storing relationship-defining information that defines the relationship between a manufacturing component where a modification is made on its production data and a designing component in design data that corresponds to the manufacturing component; cost data generating means for generating cost data of the designing component from cost data of the manufacturing component which is managed by the cost data management means on the basis of the relationship-defining information; and output control means for controlling an output of cost data of the designing component that is generated by the cost data generating means when it receives an instruction for an output of the cost data of the specific designing component in the cost data management system in accordance with the present invention.

In addition, the program product may act as any means in the cost data management system comprising: a design data management system for managing design data of each designing component for a design subject; and a production management system for managing production data of each manufacturing component and cost data of each manufacturing component as a manufacturing subject, where the design data management system and the production management system are connected to each other through a network, wherein the production management system includes a storage means for at least storing relationship-defining information that defines the relationship between a manufacturing component where a modification is made on its production data and a designing component in design data that corresponds to the manufacturing component; and a cost data generating means for generating cost data of the designing component from cost data of the manufacturing component on the basis of the relationship-defining information, and the design data management system includes an output control means for controlling an output of cost data of the designing component that is generated by the cost data generating means when it receives an instruction for an output of the cost data of the specific designing component.

Furthermore, the program product may be responsible for each step of the method for cost data management. The method comprises the steps of: storing design data of each designing component for a design subject when a design of the design subject is completed; storing cost data of each manufacturing component in production data prepared on the basis of the design data; generating cost data of the designing component from cost data of the manufacturing component on the basis of the relationship-defining information that defines the relationship between a manufacturing component where a modification is made on its production data and a designing component in design data that corresponds to the manufacturing component; and outputting cost data of the designing component when an instruction for an output of the cost data of the specific designing component is received.

According to the cost data management system of the present invention, in summary, there is provided relationship-defining information that defines the correspondence relationship between the designing component and the product component. Thus, cost data of the designing component can be generated from cost data of the manufacturing component being managed by the cost data management means on the basis of the relationship-defining information. Therefore, the designer is capable of easily obtaining cost data on a designed component basis even though the production data is modified.

As described above, therefore, the present invention has been described in detail with respect to preferred embodiments, and it will now be obvious to those skilled in the art that changes and modifications may be made without departing from the scope of the invention in its broader aspects, and it is the intention, therefore, in the appended claims to cover all such changes and modifications as fall within the true spirit of the invention.

What is claimed is:

1. A cost data management system, comprising:
design data management means for managing design data of each designing component for a design subject;
cost data management means for managing cost data of each manufacturing component in production data prepared on the basis of the design data;
storage means for at least storing relationship-defining information that defines the relationship between a manufacturing component where a modification is made on its production data and a designing component in design data that corresponds to the manufacturing component;
cost data generating means for generating cost data of the designing component from cost data of the manufacturing component which is managed by the cost data management means on the basis of the relationship-defining information; and
output control means for controlling an output of cost data of the designing component that is generated by the cost data generating means when it receives an instruction for an output of the cost data of the specific designing component.

2. A cost data management system as claimed in claim 1, further comprising:
configuration means for configuring the relationship between the designing component and the manufacturing component by relating the designing component and the manufacturing component at a ratio of 1 to 1, 2 or more to 1, or 1 to 2 or more.

3. A cost data management system as claimed in claim 1 or claim 2, wherein
the output control means displays cost data of the designing component on a screen of a display means when it receives an instruction for an output of cost data of the specific designing component, and also the contents of the correspondence relationship on a screen of the display means when the correspondence relationship with the specific designing component is included in the relationship-defining information.

4. A cost data management system, comprising:
a design data management system for managing design data of each designing component for a design subject; and
a production management system for managing production data of each manufacturing component and cost data of each manufacturing component as a manufacturing subject, where the design data management system and the production management system are connected to each other through a network, wherein
the production management system includes a storage means for at least storing relationship-defining information that defines the relationship between a manufacturing component where a modification is made on its production data and a designing component in design data that corresponds to the manufacturing component; and a cost data generating means for generating cost data of the designing component from cost data of the manufacturing component on the basis of the relationship-defining information, and
the design data management system includes an output control means for controlling an output of cost data of the designing component that is generated by the cost data generating means when it receives an instruction for an output of the cost data of the specific designing component.

5. A method for cost data management, comprising the steps of:
storing design data of each designing component for a design subject when a design of the design subject is completed;
storing cost data of each manufacturing component in production data prepared on the basis of the design data;
generating cost data of the designing component from cost data of the manufacturing component on the basis of the relationship-defining information that defines the relationship between a manufacturing component where a modification is made on its production data and a designing component in design data that corresponds to the manufacturing component; and
outputting cost data of the designing component when an instruction for an output of the cost data of the specific designing component is received.

6. A recording medium comprising a computer program that executes each of the means of the cost data management system as claimed in claim 1 or claim 4.

7. A recording medium comprising a computer program that executes each of the steps of the method as claimed in claim 5.

8. A program product for providing a computer with functions to be acted as each of the means of the cost data management system as claimed in claim 1 or claim 4.

9. A program product for bringing a computer into action to execute each of the steps of the method as claimed in claim 5.
